(19) United States
(12) Patent Application Publication
(10) Pub. No.: US 2021/0076864 A1
(43) Pub. Date: Mar. 18, 2021

(54) BREWING METHOD AND APPARATUS

(71) Applicant: VISSID COFFEE LTD., Victoria (CA)

(72) Inventor: Alexandre Tardif, Vancouver (CA)

(73) Assignee: VISSID COFFEE LTD., Victoria (CA)

(21) Appl. No.: 17/019,074

(22) Filed: Sep. 11, 2020

Related U.S. Application Data
(60) Provisional application No. 62/900,421, filed on Sep. 13, 2019.

(51) Int. Cl. A47J 31/00; A47J 31/46; A23F 5/26

(52) U.S. Cl. CPC A47J 31/002; A23F 5/262; A47J 31/469

(57) ABSTRACT

The disclosure relates to a brewing apparatus configured to carry out a submerged soluble brewing method. The apparatus consists of a holding volume into which a brewing soluble may be inserted, the brewing soluble being held in place during the brewing process by top and bottom filters. The holding volume is connected to a collection volume which captures the brewed solution as it exits the holding volume. Liquid flow into the holding volume is regulated by a processor-controlled valve or pump connected to a feed supply to produce the ideal extraction based on user inputs or preset instructions. Advantageously, the characteristics of the brew produced by the apparatus are not affected by the size of the respective volumes. Furthermore, use of the apparatus ensures that every part of the soluble is subjected to an equal or similar flow of liquid, ensuring high efficiency. Additionally, the submerged bed brewing method allows for a higher flow rate than traditional cold drip brewing, allowing for shorter brewing times.

### CROSS REFERENCE TO RELATED APPLICATION

This application claims the benefit of U.S. Provisional Application No. 62/900,421, filed Sep. 13, 2019, which is hereby incorporated by reference in its entirety.

### FIELD

The disclosure pertains generally to a brewing apparatus and related methods. More specifically, the disclosure relates to a processor-controlled brewing apparatus configured to carry out a method of controlling a flow of liquid to pass through two or more volumes within the apparatus, one of the volumes containing a soluble trapped between two filter sheets.

### BACKGROUND

Cold-brew coffee is produced using a process that uses water at room temperature or lower to extract solids from ground coffee, as opposed to traditional processes that use hot water for extraction. Traditional coffee brewing processes use hot water to extract a coffee solution from ground coffee beans in a matter of minutes. Due to the slower extraction of cold water, commonly used cold brew processes typically take 4-24 hours to produce a finished coffee solution. The slower, lower temperature extraction of cold brew processes creates a final product that has a desirable taste and aroma that is different from that of hot brewed coffee. The distinct and desirable taste of cold brew coffee is likely part of the reason it has become increasingly popular with consumers, with an increasingly large number of coffee shops offering cold brewed coffee.

Cold brew coffee is currently produced mainly by two separate processes; immersion brewing and cold drip brewing. The immersion brewing begins by immersing ground coffee in water at room temperature or lower in a container or vessel. The coffee is then left to brew for 12-24 hours in the vessel, after which time the coffee grounds are removed or filtered from the final coffee solution. The immersion cold brew process can produce a consistent final product with minimal required labor, it also has a low barrier to entry as the equipment needed is generally simple and inexpensive. The immersion method is relatively easy to scale, characteristics of the brewing process do not change for larger brew volumes. A downside of the immersion cold brew process is its inefficiency, 15-30% of the finished cold brew coffee solution is trapped within the coffee grounds and cannot be extracted without some additional processing.

The second common method of producing cold brew is the cold drip method. The process consists of dripping water at room temperature or colder onto a bed of coffee grounds, the water then steeps in the coffee grounds before passing through a filter and falling into a container below. Cold drip machines are powered by gravity in the conventional art, as illustrated in FIG. 1, they consist of an upper chamber 1, a middle chamber 2, and a lower collection container 3. Water is dripped for the upper chamber 1 onto the bed of coffee grounds 7, the drip rate is controlled by a valve 5a, the valve is adjusted manually by turning the handle or dial 5b. The water then percolates through the grounds 7, extracting coffee solubles and passing through the filter 8, before dripping into the collection container 3. The performance of the cold drip machine is determined by the extraction time, or the amount of time a given amount of water is in contact with the coffee grounds. This extraction time is determined by the flow rate into the middle chamber 2 and is directly controlled by the drip rate. For the consistency of flavor and quality of the final coffee solution, a constant drip rate (constant extraction time) is desired. This becomes an issue as the water level in the upper chamber 1 falls. As the water level falls the pressure at the valve 5a drops, reducing the drip rate. To try to maintain a consistent drip rate, the valve handle 5b must be adjusted throughout the brewing process, this makes achieving a consistent product difficult and attention intensive.

Scalability and extraction are also issues of the cold drip process. Water is dripped onto the center of the bed of grounds 7, the process relies of the horizontal diffusion of water in the coffee bed to extract the coffee solubles away from the center of the bed. If the diameter of the coffee bed 7 is too large, the extraction of the grounds furthest from the center will be limited by diffusion, leading to uneven extraction. Uneven extraction is undesirable as it can negatively affect the quality of the final product. Uneven extraction also reduces the efficiency of coffee ground utilization, as the areas furthest from the center will be less extracted than the central area that isn't limited by diffusion.

At the start of brewing, the coffee solution exiting the middle chamber 2 will initially have a high concentration of coffee solubles. The concentration of coffee solubles exiting chamber 2 will gradually fall during brewing, and the end of brewing the concentration of coffee solubles in the coffee solution exiting chamber 2 will be very low. At the end of brewing the concentration of coffee solubles in the water trapped in coffee bed 7 is also very low, meaning that the amount of desirable coffee solubles wasted is very low. For this reason, the cold drip cold brew process can be 15-30% more efficient than the immersion cold brew process.

While the disclosure is described in the context of improving the process of cold brewing coffee, and numerous examples are made using coffee as the soluble in question, it should be understood that the apparatus and methods presented herein are equally applicable to any soluble based brewing process, for example tea leaves could also be used.

### SUMMARY

The present disclosure pertains to a brewing apparatus configured to carry out a submerged soluble brewing method. The apparatus consists of a holding volume into which a brewing soluble may be inserted, the brewing soluble being held in place during the brewing process by top and bottom filters. The holding volume is connected to a collection volume which captures the brewed solution as it exits the holding volume. Liquid flow into the holding volume is regulated by a processor-controlled valve or pump connected to a feed supply to produce the ideal extraction based on user inputs or preset instructions. Advantageously, the characteristics of the brew produced by the apparatus are not affected by the size of the respective volumes. Furthermore, use of the apparatus ensures that every part of the soluble is subjected to an equal or similar flow of liquid, ensuring high efficiency. Additionally, the submerged bed brewing method allows for a higher flow rate than traditional cold drip brewing, allowing for shorter brewing times.

Thus, according to a first aspect of the disclosure, there is provided a method of brewing a drink, the method comprising: supplying, via an electronic valve or pump controlled by a processor, a flow of liquid into a first volume until the liquid level in the first volume reaches a maximum height of the first volume; passing the liquid into a second volume at a first predefined flow rate, the second volume being bordered by first and second filter sheets and containing a mass of soluble held between the filter sheets; after a predefined amount of time, the predefined amount of time having been calculated to coincide with the solute held in the second volume becoming saturated with the liquid, increasing the flow rate to a second predefined flow rate and collecting the liquid having passed through the soluble in a third volume.

In some embodiments, the method further comprises controlling, by the processor, the liquid supplied via the electronic valve or pump to be supplied in pulses of predefined length and volume, each pulse being interspersed with a period of predefined length where no liquid is supplied. Additionally, after the predefined amount of time for the soluble to become saturated has elapsed, the method may comprise changing the length of the period of predefined length between each pulse to a different predefined length.

In some embodiments, the first volume is shaped to comprise a buffer volume and a distribution volume, the maximum height of the buffer volume being greater than the maximum height of the distribution volume, and wherein the method further comprises regulating the pressure of the liquid passing through the soluble contained in the second volume by controlling the difference in liquid height levels between the buffer volume and the distribution volume.

In some embodiments, the method further comprises receiving one or more inputs from a user, the one or more inputs comprising one or more of a grind size of the soluble, an total mass of the soluble, a type of the soluble, and a target concentration for the resultant brew, and wherein the method further comprises calculating, by the processor, the predefined flow rates based on the one or more inputs.

In some embodiments, the liquid is supplied by an electronic valve connected to a pressurized liquid supply. The pressurized water supply may originate from a liquid reservoir, the minimum liquid level of the liquid reservoir being at a height equal to or greater than the maximum liquid level of the first volume. Advantageously, no energy is required to pressurize the supply feed in such embodiments.

Alternatively, the liquid may be supplied by an electronic pump connected to an unpressurized water supply.

The apparatus may be configured to accept either coffee or tea as the soluble. The liquid used is usually water. Furthermore, as mentioned above the apparatus is particularly suited to cold-brewing methods, therefore the liquid from the supply feed may be introduced at a temperature of 25 degrees Celsius or less.

In some embodiments, the predefined amount of time for the soluble to become saturated is calculated based on the sizes of the first and second volumes, which are pre-programmed into the processor, and the mass of solute contained in the second volume, which is input to the processor by a user.

According to a second aspect of the disclosure, a brewing apparatus is provided, the brewing apparatus comprising: a controller; a dispensing unit comprising a supply feed and an electrically controlled valve or pump connected to and controlled by the controller and configured to measure and control a flow of liquid supplied by the supply feed; a container, the container comprising: a first volume connected to the dispensing unit and configured to receive any liquid dispensed by the dispensing unit; a second volume connected to the first volume, the second volume being defined by first and second filter sheets and being configured to hold a mass of soluble in place in the second volume; a third volume connected to the second volume and configured to collect any liquid having passed through a soluble held in place in the second volume.

The disclosed brewing apparatus may be configured to carry out one or more of the operations described above in relation to the disclosed methods in any combination and for each operation or combination of operations the apparatus will have characteristics that allow it to do so as will be described in the detailed description section.

### BRIEF DESCRIPTION OF THE DRAWINGS

Various embodiments are disclosed in the following detailed description and accompanying drawings.

FIG. 1 shows a cross-sectional view of a cold-drip cold brew machine (Prior Art).

FIG. 2 shows a cross-sectional view of a first example configuration of a brewing apparatus according to the disclosure.

FIG. 3 shows a cross-sectional view of a second example configuration of a brewing apparatus according to the disclosure.

FIG. 4 shows a cross-sectional view of a third example configuration of a brewing apparatus according to the disclosure.

FIG. 5 shows a perspective view of the first configuration for illustrative purposes.

FIG. 6 shows a cross-sectional view of a fourth example configuration of a brewing apparatus according to the disclosure which is similar to the first configuration but which is fed by a gravity driven liquid supply.

FIG. 7 shows a cross-sectional view of a fifth example configuration of a brewing apparatus according to the disclosure which is similar to the first configuration but which is fed by a pump driven liquid supply.

FIG. 8 shows a components block diagram of an example configuration of the apparatus of the disclosure.

FIG. 9 shows flow diagram for an example implementation of the method of the disclosure implemented through the apparatus.

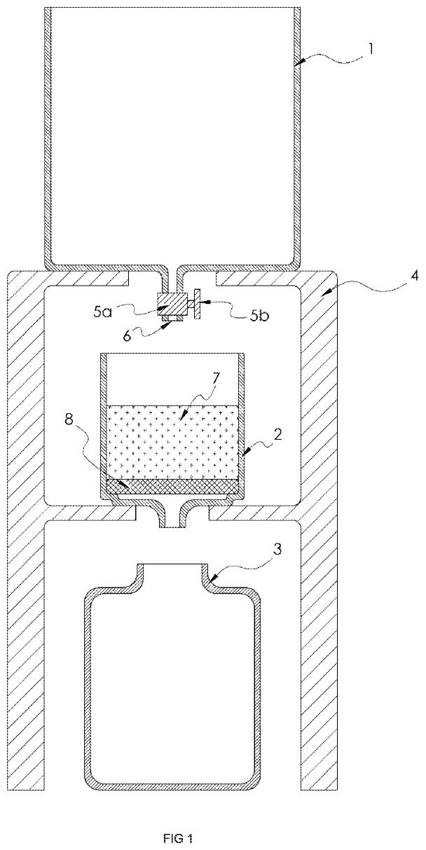

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the disclosure, as set forth in the claims.

### DETAILED DESCRIPTION

The following is a detailed description of exemplary embodiments to illustrate the principles of the disclosure. The embodiments are provided to illustrate aspects of the disclosure, but the disclosure is not limited to any embodiment. The scope of the disclosure encompasses numerous alternatives, modifications and equivalent; it is limited only by the claims.

Numerous specific details are set forth in the following description in order to provide a thorough understanding of the disclosure. However, the disclosure may be practiced according to the claims without some or all of these specific details. For the purpose of clarity, technical material that is known in the technical fields related to the disclosure has not been described in detail so that the disclosure is not unnecessarily obscured.

The following description will refer to like mechanisms in different specific illustrative embodiments of the disclosure shown in the figures. Components of the apparatus described herein having like reference numerals and names (like reference numeral including any reference numerals ending in the same two numbers such as for example 57 and 457) can be assumed to have similar properties and features which allow them to carry out similar operations.

The disclosed systems, methods, and apparatus are not limited to any specific aspect or feature or combinations thereof, nor do the disclosed systems, methods, and apparatus require that any one or more specific advantages be present or problems be solved.

As used herein, soluble or brewing soluble refers to solids that contain soluble compounds to be extracted. For example, coffee grounds are referred to herein as a soluble. In some cases, soluble refers to the soluble compounds and the meaning will be clear from the context.

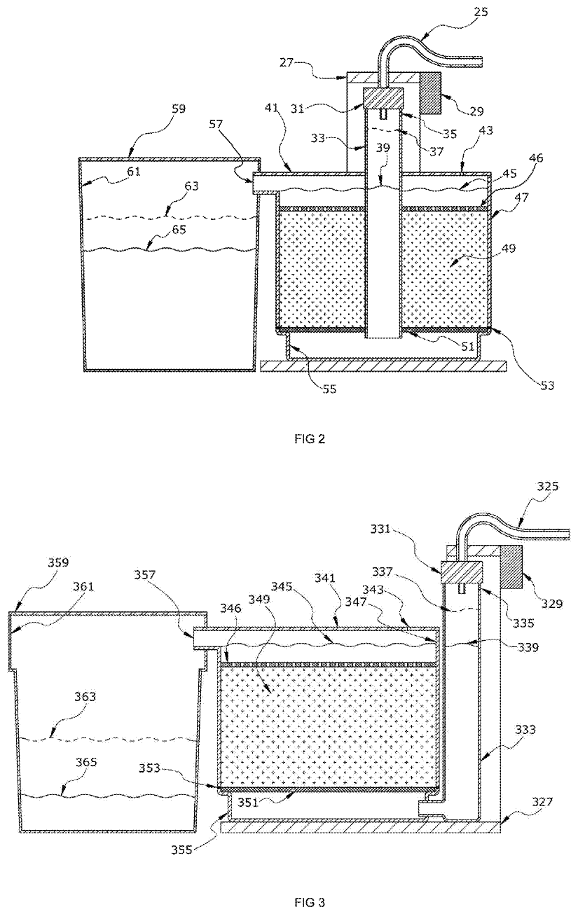

Referring to FIG. 2, a first example configuration of the apparatus of the disclosure is shown. The general operations of the apparatus and the related novel brewing methods which are enabled by its distinguishing features will be explained, with alternative example configurations illustrated and described with reference to FIGS. 3-7.

In the present example water is dispensed by dispensing unit 31 into buffer volume 33. Water is provided to the dispensing unit by water line 25. Water line 25 can receive water from several potential sources. Water sources could consist of, a pressurized water source from a filter system or utility water supply, however alternative mechanisms may also be employed as will be described below.

Operation of the apparatus begins with an operator adding ground coffee, which is the brewing soluble used in the present example, to holding vessel 47 by removal of holding vessel lid 41 and top filter 46. After being added to holding vessel 47, the ground coffee forms coffee bed 49, resting on bottom filter 51.

Controller 29 is responsible for automating the brewing process after the machine has been started. Controller 29 uses the flowrate or volume of water dispensed received from water dispenser 31 as feedback, and controls water dispenser 31 to release a target amount or rate of water into buffer volume 33.

Dispensing unit 31 receives instructions from controller 29 to control the rate of flow of water into the buffer volume 33. In order to achieve this dispensing unit 31 comprises an electronic valve or gate, and can further comprise a pump and/or water flow sensor. Thus, dispensing unit 31 both dispenses water from supply source 25 and sends a signal relating to a measured volume or flow rate of the water dispensed to controller 29.

Dispensing unit 31 could in some examples consist of a single part that can both dispense water and measure the volume or flow rate of the dispensed water. A single part dispensing unit 31 could consist of, but is not limited to, a diaphragm pump, vane pump, gear pump, piston pump, screw pump or peristaltic pump.

As buffer volume 33 is filled it dispenses water into water distribution volume 55. Buffer volume 33 serves to apply water pressure that causes the water level to rise in distribution volume 55 while the water in buffer volume 33 is at a higher level.

Water distribution volume 55 is shaped to ensures that liquid dispensed from dispenser 31 applies an even pressure over the entire area of bottom filter 51. Water distribution volume 55 can either be permanently fixed to holding vessel 47 or can be removable where it seals against holding vessel 47 with sealing medium 53. Sealing medium 53 could consist of, but is not limited to, a latex or silicone O-ring or gasket.

Water dispensed into buffer volume 33 enters water distribution volume 55, filling it up before beginning to pass through bottom filter 51.

The brewing characteristics are dominated by the large resistance to flow of the coffee bed 49, intermittent small changes in the height of water level 39 have a minimal effect on brewing. The use of a continuous brewing process and automated control allows increased flexibility, as the final produced cold brew can be produced at within a large range of target concentrations, where concentration is determined by the percent of dissolved coffee solubles within the final coffee solution.

Bottom filter 51 consists of a rigid small pore filter that supports coffee bed 49 and serves to separate coffee bed 49 from water distribution volume 55. Bottom filter 51 may have a pore size of 1.5 mm to 40 micrometers for the applications described herein and has a primary function of separating coffee bed 49 from water distribution volume 55. Advantageously, the flow resistance provided by its small pore size also further ensures that the pressure across its surface and into coffee bed 49 is uniform. Bottom filter 51 could consist of, but is not limited to, a perforated stainless steel, aluminium, or polymer filter, a rigid stainless steel, aluminium or polymer mesh filter, or a ceramic filter.

After passing through bottom filter 51, the dispensed water enters coffee bed 49. Even pressure applied across coffee bed 49 eliminates the issue of limiting horizontal diffusion encountered in classic cold drip brewing and allows for even extraction independent of the diameter of coffee bed 49. As mentioned, the diameter of coffee bed 49 can thus be increased to any size without affecting the extraction characteristics.

Water dispensed by dispensing unit 31 travels through coffee bed 49 in two stages. The first stage is deemed the soak stage. The soak stage involves gradually saturating the coffee bed from the bottom up with dispensed water. The soak stage allows the majority of the dissolved and trapped gases contained in coffee bed 49 to exit the coffee grounds as coffee bed 49 is gradually saturated. If the soak stage is conducted too quickly dissolved gas in the coffee grounds will create bubbles which create a large resistance to flow, blocking the flow of water into the above height of coffee bed 49. This blocked flow can both increase the time required for bed saturation and increase the pressure required to saturate the bed, which can reduce final cold brew quality.

Saturation of coffee bed 49 continues until the liquid level reaches top filter 46. Top filter 46 forces the coffee bed to become submerged during brewing and prevents coffee grounds from exiting the holding vessel at output 57. Lid 41 serves to prevent the accidental introduction of unwanted contaminants to the holing vessel, it may either have a loose fit on holding vessel 47 or small vent 43 to allow air to escape.

After saturation coffee bed 49 still contains some dissolved gases, which makes its bulk density lower than water, meaning it will float if not constrained. Top filter 46 serves to contain coffee bed 49, ensuring it does not exit holding vessel 47. Top filter 46 has large pore size on the order of 3 mm-0.5 mm, though this is significantly larger than the size of an individual coffee particle, cohesive forces within the coffee bed prevent virtually all coffee particles from passing through top filter 46.

Once the water level in holding chamber 47 rises past top filter 46, coffee bed 49 becomes fully submerged and the soak stage is complete. Once the soak stage is complete, the brew stage begins. The slow saturation of coffee bed 49 removes the majority of the dissolved and trapped gases from the bed. After the soak stage coffee bed 49 offers a significantly lower resistance to flow. The liquid level in holding vessel 47 continues to rise as water is continually dispensed into buffer volume 33, until it reaches output 57. After reaching output 57, the now finished cold brew solution exits holding vessel 47 and enters collection container 61. Liquid level 65 continues to rise in collection container 61 until a target dispensed volume, represented by final liquid level 63, is reached. Collection container 61 can be removable from holding vessel 47 or it can be permanently fixed, if removable it can either have a lose fit with holding vessel 47 or a seal with holding vessel 47. Lid 59 can either be permanently fixed to holding vessel 47 or removable.

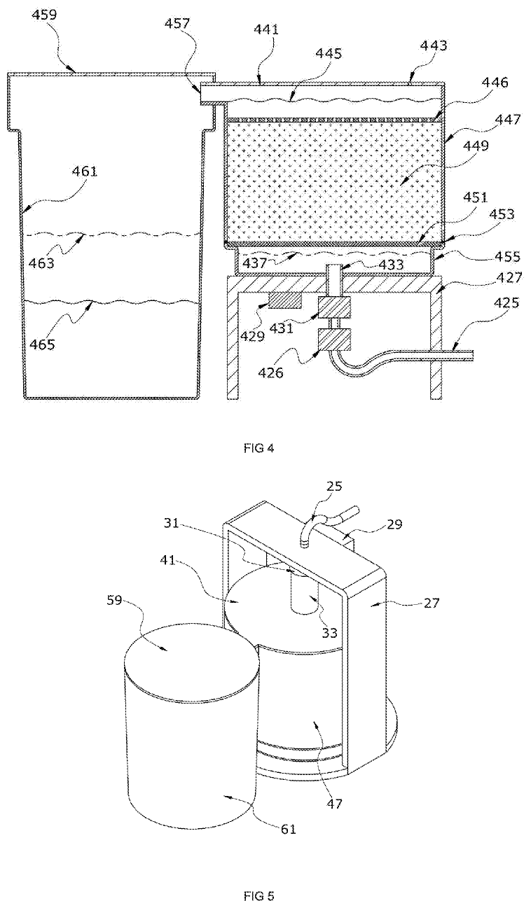

FIG. 2, FIG. 3, and FIG. 4 show different buffer volume configurations.

FIG. 2 shows buffer volume 33 partially nested within holding volume 47. Buffer volume 33, as shown in FIG. 2, could be removable, fixed to bottom filter 51, fixed to water distribution volume 55, or fixed to holding vessel 47, it could be placed anywhere within holding vessel 47 and does not need to be centred as shown. Buffer volume 33, as shown in FIG. 2 is not required to seal against top filter 46 or bottom filter 51 and can have a lose fit with both.

FIG. 3 shows buffer volume 333 outside holding vessel 347. Buffer volume 333, as shown in FIG. 3, could be removable where it would seal against water distribution volume 355, or it could be permanently fixed to water distribution volume 355.

FIG. 4 shows buffer volume 333 as direct input to water distribution volume 355. The configuration shown is FIG. 4 does not use buffer volume 433 as a pressure regulation mechanism, instead using pressure regulator 426 placed on water line 425 before water dispensing unit 431 to ensure the water pressure applied to water distribution volume 455 is sufficiently low. Buffer volume 433, as shown in FIG. 4, seals against water distribution volume 455 and can be removable or fixed to water distribution volume 455.

FIG. 5 is simply a perspective view of the configuration illustrated by FIG. 2 and has identical mechanisms identified by identical reference numerals.

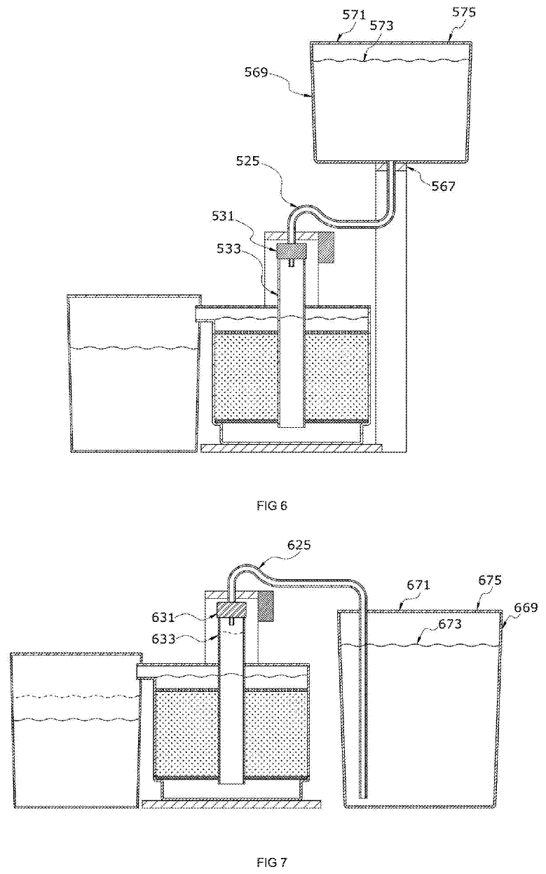

FIG. 6 and FIG. 7 illustrate configurations of the apparatus of the disclosure having different mechanisms for delivering a supply of liquid to the apparatus.

Referring to FIG. 6, a gravity-fed water supply mechanism is shown in combination with the apparatus, where the minimum water level of bulk supply 573 is above the max height of buffer volume 533. This water supply method uses the force of gravity to allow the dispensing of water.

Referring to FIG. 7 a pumped water supply mechanism is shown in combination with the apparatus, where the minimum water level of bulk supply 673 is at or below the max height of buffer volume 633. As shown in FIG. 7, water line 625 takes water from bulk water supply 673. Bulk water supply 673 is contained by vessel 669. Vessel 669 may have a lid 671 to prevent the accidental introduction of foreign contaminants, lid 671 may either have small vent 675 or a loose fit with vessel 669 so no negative or positive air pressure develops in vessel 669.

It should be noted that for the pressurized water supply, pumped water supply, and gravity supply methods, dispensing unit 31, 331, 431, 531, 631 may be placed at any location along water line 25, 325, 425, 525, and 625 respectively, additional tubing may be required to direct the dispensed water into buffer volume 33, 333, 433, 533, 633. This may be useful in embodiments where it is desirable to reduce the overall height of the apparatus.

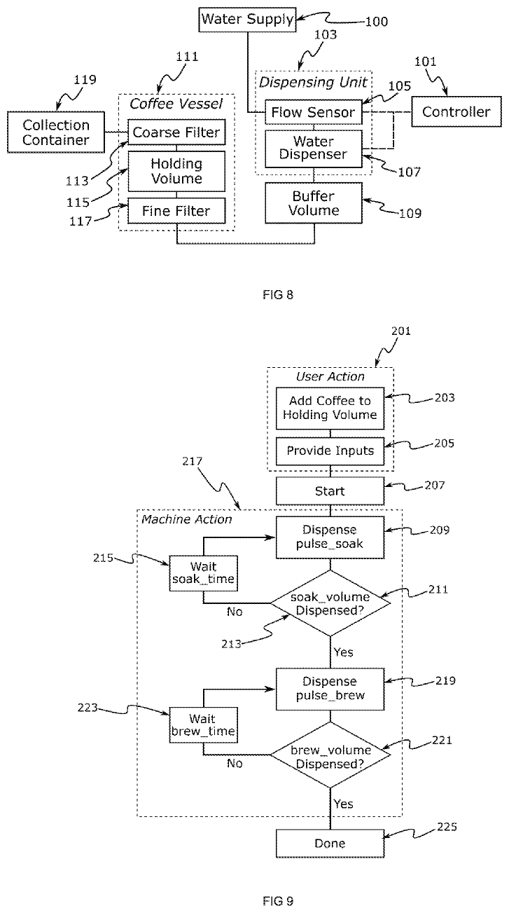

Referring to FIG. 8, a components view of the apparatus according to the disclosure is shown which applies to all embodiments, thereby showing the basic functional structure of the apparatus.

Dispensing unit 103 could also consist of a combination of water dispenser 107 and flow sensor 105 with the water dispenser 107 being used to dispense water and flow meter 105 used to measure to volume or flow rate of water dispensed. The flow sensor 105 could consist of, but is not limited to, a gear flow meter, turbine flow meter, venturi flow meter, optical flow meter or ultrasonic flow meter. The water dispenser 107 could consist of, but is not limited to, a mechanical valve, an electrically controlled valve or solenoid valve, or an electrically controlled pump.

Referring to FIG. 9, a flow diagram of an example control method for operating the controller 101 is shown. In the example of FIG. 9 a discretized continuous process is shown, however in other embodiments the discretization could be foregone for a fully continuous process. The physical components of the apparatus on which the method is implemented are denoted by the reference numerals of FIG. 2.

The operator adds coffee 203 and provides inputs 205 before starting the machine. Inputs provided by the operator allow for adjustments of the brew cycle based on the target concentration, target volume, and type of coffee added to holding volume 47.

An operator may select the amount of time for either the total brew, or soak and brew stages separately. Operator input may be provided by any suitable means such as buttons or dials connected to the controller, with a screen providing feedback for the user. In some embodiments the apparatus may also connect to a computer, smartphone, other device, and use that device as the user input instead.

After the apparatus is initialized at machine start 207, controller 29 controls dispensing unit 31 to dispense pulse_soak 209, where pulse_soak 209 represents an amount of water volume dispensed. After dispensing pulse_soak 209, controller 29 waits for soak_time 215, where soak_time is a variable that represents a calculated amount of time. Both variables pulse_soak 209 and soak_time 215 are calculated from a target average flow rate that is selected from empirical data.

As the brewing characteristics do not depend on the diameter of coffee bed 49, the target average flow rate is determined to be a target average flow rate per unit area. The ideal target average flow rate per unit area is largely dependent on the grind size of coffee used, type of coffee used, and the height of coffee bed 49.

Testing shows that the ideal target average flow rate per unit area for the soak stage falls between 250-1800 ml/(minute*meter\hat{ }2), depending of grind size, coffee type, and bed height parameters. Variables soak_time 215 and pulse_soak 209 are calculated from this target average flow rate per area and the planar area of coffee bed 49 that is perpendicular to the flow direction. Controller 29 tracks the volume dispensed during the soak stage, by calculating the number of pulse_soak 209 cycles dispensed and the volume of each cycle.

The controller 29 will monitor the dispensation of water from the dispenser 31 to determine once a target soak volume has been dispensed, the target soak volume being calculated based on known volumes 33, 47, and 55 and the mass and density of the saturated soluble. For example it may be based on the total internal volume of the vessel using the known volumes and the volume of input soluble which itself can be calculated based on the input mass and the known density at saturation.

Once a target soak volume has been dispensed, controller 29 moves to the brew stage. The brew stage uses the same control method as the soak stage with brew_time 223 replacing soak_time 215, and pulse_brew 219 replacing pulse_soak 209. Pulse_brew 219 and brew_time 223 are also calculated from a target average flow rate per area. Testing shows that the ideal target average flow rate per unit area for the brew stage falls between 1,000-11,000 ml/(minute*meter\hat{ }2), depending of grind size, coffee type, and bed height parameters.

As shown in FIG. 9, controller 29 repeats the dispense pulse_brew 219 then wait brew_time 223 cycle until a target brew volume has been dispensed, at which point brewing is complete. Controller 29 could employ a fully continuous brewing method, where pulse_soak 209 and soak_time 215 are replaced by a single target flow rate continually dispensed by dispensing unit 31. This target flow rate is calculated from the planar area of coffee bed 49 that is perpendicular to the flow direction, and the respective soak stage and brew stage target average flow rates per area.

The references to a predefined flow rate of liquid from the dispenser 31 as used herein can either refer to a measured instantaneous flow rate or an average flow rate over a period of time, such as for example an average flow rate over a pulse and brew cycle of the controller, the term should not be construed narrowly.

It is to be understood that the embodiments herein described are merely illustrative of the application of the principles of the disclosure. Reference herein to details of the illustrated embodiments is not intended to limit the scope of the claims, which themselves recite those features regarded as essential to the disclosure.

The disclosed embodiments are illustrative, not restrictive. While specific configurations of the brewing apparatus and method have been described in a specific manner referring to the illustrated embodiments, it is understood that the disclosure can be applied to a wide variety of brewing solutions which fit within the scope and spirit of the claims. There are many alternative ways of implementing the disclosure.

I claim:

1. A method of brewing a drink, the method comprising:
supplying, via an electronic valve or pump controlled by a processor, a flow of a liquid into a first volume until a liquid level in the first volume reaches a maximum height of the first volume;
passing the liquid from the first volume into a second volume at a first predefined flow rate, the second volume being bordered by first and second filter sheets and containing a mass of a soluble held between the first and second filter sheets; and
after a predefined amount of time, the predefined amount of time having been calculated to coincide with a solute held in the second volume becoming saturated, changing the first predefined flow rate to a second predefined flow rate and collecting a liquid having passed through the solute in a third volume.

2. The method according to claim 1, wherein the method further comprises controlling, by the processor, the flow of liquid into the first volume supplied via the electronic valve or pump to be supplied in pulses of predefined length and volume, each pulse being interspersed with a period of predefined length where no liquid is supplied.

3. The method according to claim 2, wherein, the method further comprises, after the predefined amount of time for the soluble to become saturated has elapsed, changing a length of the period of predefined length between each pulse to a different predefined length.

4. The method according to claim 1, wherein the first volume is shaped to comprise a buffer volume and a distribution volume, the maximum height of the buffer volume being greater than the maximum height of the distribution volume, and wherein the method further comprises regulating a pressure of a liquid passing through the soluble contained in the second volume by controlling a difference in liquid height levels between the buffer volume and the distribution volume.

5. The method according to claim 1, wherein the method further comprises receiving one or more inputs from a user, the one or more inputs comprising one or more of a grind size of the soluble, an total mass of the soluble, a type of the soluble, and a target concentration for a resultant brew, and wherein the method further comprises calculating, by the processor, the first and second predefined flow rates based on the one or more inputs.

6. The method according to claim 1, wherein the flow of liquid into the first volume received by an electronic valve connected to a pressurized liquid supply.

7. The method according to claim 6, wherein the liquid is water and the pressurized liquid supply originates from a liquid reservoir, a minimum liquid level of the liquid reservoir being at a height equal to or greater than a maximum liquid level of the first volume.

8. The method according to claim 1, wherein the flow of liquid is supplied by an electronic pump connected to an unpressurized water supply.

9. The method according to claim 1, wherein the soluble is coffee or tea and the liquid is water that is introduced at a temperature of 25 degrees Celsius or less.

10. The method according to claim 1, wherein the predefined amount of time for the soluble to become saturated is calculated based on sizes of the first and second volumes, which are pre-programmed into the processor, and a mass of solute contained in the second volume, which is input to the processor by a user.

11. A brewing apparatus, comprising:
a controller;
a dispensing unit comprising a supply feed and an electrically controlled valve or pump connected to and controlled by the controller and configured to measure and control a flow of liquid supplied by the supply feed; and
a container, the container comprising:
a first volume connected to the dispensing unit and configured to receive any liquid dispensed by the dispensing unit;
a second volume connected to the first volume, the second volume being defined by first and second filter sheets and being configured to retain a mass of soluble in place in the second volume; and
a third volume connected to the second volume and configured to collect any liquid having passed through a soluble retained in the second volume.

12. The brewing apparatus according to claim 11, wherein the first volume is shaped to comprise a buffer volume and a distribution volume, a maximum height of the buffer volume being greater than the maximum height of the distribution volume, the brewing apparatus being thereby configured to regulate a pressure of the liquid passing through the mass of soluble contained in the second volume by controlling a difference in liquid height levels between the buffer volume and the distribution volume.

13. The brewing apparatus according to claim 11, wherein the controller is further configured to control the dispensing unit to supply liquid in pulses of predefined length and volume, each pulse being interspersed with a period of predefined length where no liquid is supplied.

14. The brewing apparatus according to claim 13, wherein the controller is further configured to determine that a predefined amount of time for the retained mass of soluble to become saturated with liquid has elapsed, and in response to change a length of the period of predefined length between each pulse to a different predefined length.

15. The brewing apparatus according to claim 14, wherein the predefined amount of time for the soluble to become saturated is calculated based on sizes of the first and second volumes and a mass of solute contained in the second volume.

16. The brewing apparatus according to claim 11, wherein the brewing apparatus further comprises a user interface, and the controller is further configured to receive one or more inputs from a user interface.

17. The brewing apparatus according to claim 16, wherein the one or more inputs comprise one or more of a grind size of the soluble, an input mass of the soluble, a type of the soluble, and a target concentration for a resultant brew, and the controller is further configured to calculate a flow rate at which liquid is dispensed from the dispensing unit based on the one or more inputs.

18. The brewing apparatus according to claim 11, wherein the dispensing unit comprises an electronic valve connected to a pressurized liquid supply.

19. The brewing apparatus according to claim 11, wherein the brewing apparatus further comprises a liquid reservoir connected to the supply feed, a minimum liquid level of the liquid reservoir being at a height equal to or greater than a maximum liquid level of the first volume.

20. The brewing apparatus according to claim 11, wherein the dispensing unit comprises an electronic pump connected to an unpressurized water supply and the soluble is coffee or tea and the liquid is water that is introduced at a temperature of 25 degrees Celsius or less.
